(19) United States
(12) Patent Application Publication
(10) Pub. No.: US 2023/0172276 A1
(43) Pub. Date: Jun. 8, 2023

(54) HEATING BODY AND AEROSOL-GENERATION DEVICE

(71) Applicant: SHENZHEN SMOORE TECHNOLOGY LIMITED, Shenzhen (CN)

(72) Inventors: Hongming ZHOU, Shenzhen (CN); Taowen LIU, Shenzhen (CN); Feng LIANG, Shenzhen (CN); Junjie XIAO, Shenzhen (CN); Hua CHEN, Shenzhen (CN); Lusheng JIANG, Shenzhen (CN)

(21) Appl. No.: 18/155,101

(22) Filed: Jan. 17, 2023

Related U.S. Application Data
(63) Continuation of application No. PCT/CN2021/104469, filed on Jul. 5, 2021.

(30) Foreign Application Priority Data
Jul. 20, 2020 (CN) 202010697177.7

(51) Int. Cl. A24F 40/465; A24F 40/42; A24F 40/485; H05B 6/10

(52) U.S. Cl. CPC A24F 40/465; A24F 40/42; A24F 40/485; H05B 6/105

(57) ABSTRACT

A heating body detachably disposed in a aerosol-generation device is disclosed. The heating body includes a housing and a heating element. The housing is configured to accommodate an aerosol-generation substrate and includes an air inlet hole and an air outlet hole. The heating element is disposed in the housing and configured to generate heat through an eddy current in an alternating magnetic field. The aerosol-generation substrate generates an aerosol in response to the heat from the heating element.

### CROSS-REFERENCE TO RELATED APPLICATIONS

This application is a continuation of International Application No. PCT/CN2021/104469, filed on Jul. 5, 2021, which claims priority to Chinese Patent Application No. 202010697177.7, filed on Jul. 20, 2020. The disclosures of all of these applications are incorporated herein by reference in their entireties.

### TECHNICAL FIELD

This application relates to the technical field of baking devices, and in particular, to a heating body and an aerosol-generation device.

### BACKGROUND

In a conventional electronic vaporizer or the related fields thereof, a heating component generally uses a heating wire to directly perform heating and vaporization. The heating component needs to be electrically connected to a main body of the electronic vaporizer through a wire, and installation of the heating component is relatively complex. In addition, to improve the heating efficiency, the heating wire is in direct and close contact with an herbal or paste aerosol-generation substrate, so that the heating wire may be easily polluted. After being polluted, the heating component can be hardly disassembled for separate cleaning.

### SUMMARY

According to embodiments of this application, a heating body and an aerosol-generation device are provided.

This application provides a heating body, configured to be detachably arranged in an aerosol-generation device, the heating body including a housing and a heating element, where the interior of the housing is hollow for accommodating an aerosol-generation substrate, and the housing is provided with an air inlet hole and an air outlet hole; and the heating element is arranged in the housing, and the heating element is configured to generate an eddy current in an alternating magnetic field to generate heat to heat the aerosol-generation substrate to generate an aerosol.

In an embodiment, the housing includes a first cylinder body, an upper plug, and a lower plug; the upper plug and the lower plug are respectively arranged at two opposite ends of the first cylinder body, and the heating element is detachably arranged in the first cylinder body; the air inlet hole is provided on the lower plug or on a cylinder wall of one end of the first cylinder body that is close to the lower plug; and the air outlet hole is provided on the upper plug.

In an embodiment, outer surfaces of the upper plug and the lower plug are provided with airflow grooves, and the airflow grooves are configured to guide an airflow and prevent the airflow from being blocked.

In an embodiment, the heating element is a sheet heating element; and an inner wall of the first cylinder body is provided with a first clamping groove, and the sheet heating element is clamped in the first clamping groove; or an end surface of the lower plug that is close to the first cylinder body is provided with a second clamping groove, and the sheet heating element is clamped in the second clamping groove.

In an embodiment, the sheet heating element includes a magnetic metal conductor, a first thermal conductive layer, and a second thermal conductive layer in sequence from the center to the outside, a thermal conductivity of the first thermal conductive layer is higher than that of the second thermal conductive layer, and the second thermal conductive layer is in direct contact with the aerosol-generation substrate.

In an embodiment, the heating element is a tubular heating element; and an end surface of the lower plug close to the first cylinder body is provided with a third clamping groove, and the tubular heating element is clamped in the third clamping groove; or an end surface of the lower plug close to the first cylinder body is provided with a protrusion, and the tubular heating element is sleeved on and fixed outside the protrusion.

In an embodiment, the tubular heating element includes a magnetic metal conductor, a first thermal conductive layer, and a second thermal conductive layer in sequence from an inner wall to an outer wall, a thermal conductivity of the first thermal conductive layer is higher than that of the second thermal conductive layer, and the second thermal conductive layer is in direct contact with the aerosol-generation substrate.

In an embodiment, a thickness of the magnetic metal conductor ranges from 0.1 mm to 0.6 mm; the thermal conductivity of the first thermal conductive layer ranges from 15 W/(m·k) to 26 W/(m·k), and a thickness thereof ranges from 0.02 mm to 0.5 mm; and the thermal conductivity of the second thermal conductive layer ranges from 0.04 W/(m·k) to 0.08 W/(m·k), and a thickness thereof ranges from 0.02 mm to 0.05 mm.

In an embodiment, an outer surface of the heating element is a smooth surface or a frosted surface; or an outer surface of the heating element is provided with a protruding structure or a groove structure.

In an embodiment, the roughness Ra of the smooth surface is less than or equal to 6.3 μm; the roughness Ra of the frosted surface is greater than or equal to 50 μm; and a height of the protruding structure or a depth of the groove structure ranges from 0.1 mm to 0.3 mm.

In an embodiment, the heating element is a sheet heating element, the protruding structure is a horizontal strip-shaped protrusion, a vertical strip-shaped protrusion, or a dot-shaped protrusion, and the groove structure is a horizontal strip-shaped groove, a vertical strip-shaped groove, or a dot-shaped groove,

in an embodiment, the heating element is a tubular heating element, the protruding structure is a radial annular protrusion, an axial strip-shaped protrusion, or a spiral protrusion, and the groove structure is a radial annular groove, an axial strip-shaped groove, or a spiral groove,

In an embodiment, the upper plug and/or the lower plug are made of a silica gel material; or the upper plug and/or the lower plug includes a plug pillar and a sealing ring arranged outside the plug pillar.

This application further provides an aerosol-generation device, including a main body and the heating body according to any of the foregoing embodiments, where an accommodating cavity is provided in the main body, and a magnetic induction coil is arranged outside a cavity wall of the accommodating cavity; and a power supply component is further arranged in the main body, the magnetic induction coil is electrically connected with the power supply component, and the magnetic induction coil is configured to form an alternating magnetic field in the accommodating cavity.

In an embodiment, the aerosol-generation device further includes a suction nozzle, where the suction nozzle is in communication with both the air inlet hole and the air outlet hole, the suction nozzle is configured to detachably cover an upper end of the main body, and the suction nozzle is further configured to press and fix the heating body in the accommodating cavity.

In an embodiment, there is a magnetic attraction force between the suction nozzle and the main body, and the suction nozzle is connected with the main body through the magnetic attraction force. In an embodiment, the aerosol-generation device further includes a ferrite film sleeved on the outside of the magnetic induction coil.

The heating body and the aerosol-generation device in this application have the following beneficial effects:

According to the heating body and the aerosol-generation device of this application, by adopting a magnetic induction heating manner, arrangement of a conductive circuit structure between the heating body and the main body is avoided, and the heating body is detachably arranged in the aerosol-generation device, so that the heating body may be taken out independently. Therefore, it is convenient to place an aerosol-generation substrate in the heating body, and it is convenient to replace and clean the heating body, so that the heating body may be manufactured into disposable consumables and may also be reused.

### BRIEF DESCRIPTION OF THE DRAWINGS

The foregoing and other objectives, features, and advantages of this application becomes more apparent from a more detailed description of the exemplary embodiments of this application shown in the accompanying drawings. The same reference numerals refer to the same parts in all accompanying drawings, and the accompanying drawings are not deliberately drawn to scale according to an actual size, and a focus is demonstrating the main idea of this application.

FIG. 1 is a schematic longitudinal cross-sectional view of an aerosol-generation device according to an embodiment of this application.

FIG. 2 is a schematic exploded structural view of a heating body according to an embodiment of this application.

FIG. 3 is a schematic exploded structural view of a heating body according to another embodiment of this application.

FIG. 4 is a schematic exploded structural view of a heating body according to still another embodiment of this application.

FIG. 5 is a schematic structural diagram of an end of a lower plug of the heating body in

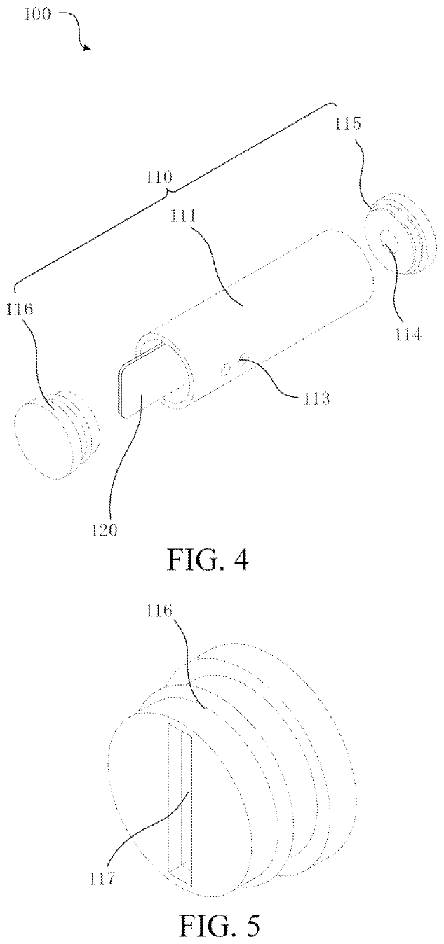

FIG. 4 that is close to a first cylinder body.

FIG. 6 is a schematic longitudinal cross-sectional view of an aerosol-generation device according to another embodiment of this application.

FIG. 7 is a schematic exploded structural diagram of a heating body according to another embodiment of this application.

FIG. 8 is a schematic structural diagram of an end of a lower plug of the heating body in FIG. 7 that is close to a first cylinder body.

FIG. 9 is a schematic structural diagram of a sheet heating element according to an embodiment of this application.

FIG. 10 is a schematic structural diagram of a sheet heating element according to another embodiment of this application.

FIG. 11 is a schematic structural diagram of a sheet heating element according to another embodiment of this application.

FIG. 12 is a schematic structural diagram of a sheet heating element according to another embodiment of this application.

FIG. 13 is a schematic structural diagram of a sheet heating element according to another embodiment of this application.

FIG. 14 is a schematic structural diagram of a sheet heating element according to another embodiment of this application.

FIG. 15 is a schematic structural diagram of a sheet heating element according to another embodiment of this application.

FIG. 16 is a schematic exploded structural view of a heating body according to another embodiment of this application.

FIG. 17 is a schematic structural diagram of an end of a lower plug of the heating body in FIG. 16 that is close to a first cylinder body.

FIG. 18 is a schematic exploded structural view of a heating body according to another embodiment of this application.

FIG. 19 is a schematic structural diagram of an end of a lower plug of the heating body in FIG. 18 that is close to a first cylinder body.

FIG. 20 is a schematic longitudinal cross-sectional view of an aerosol-generation device according to another embodiment of this application.

FIG. 21 is a schematic exploded structural view of a heating body according to another embodiment of this application.

FIG. 22 is a schematic longitudinal cross-sectional view of an aerosol-generation device according to another embodiment of this application.

FIG. 23 is a schematic exploded structural view of a heating body according to another embodiment of this application.

FIG. 24 is a schematic structural diagram of a tubular heating element according to an embodiment of this application.

FIG. 25 is a schematic structural diagram of a tubular heating element according to another embodiment of this application.

FIG. 26 is a schematic structural diagram of a tubular heating element according to another embodiment of this application.

FIG. 27 is a schematic structural diagram of a tubular heating element according to another embodiment of this application.

FIG. 28 is a schematic structural diagram of a tubular heating element according to another embodiment of this application.

FIG. 29 is a schematic structural diagram of a tubular heating element according to another embodiment of this application.

### DETAILED DESCRIPTION

To make the foregoing objectives, features, and advantages of this application more comprehensible, detailed description is made to specific implementations of this application below with reference to the accompanying drawings. In the following description, many specific details are described for fully understanding this application. However, this application may be implemented in many other manners different from those described herein. A person skilled in the art may make similar improvements without departing from the connotation of this application. Therefore, this application is not limited to the specific embodiments disclosed below

In the description of this application, it should be understood that, orientation or position relationships indicated by terms such as “center”, “longitudinal”, “transverse”, “length”, “width”, “thickness”, “up”, “down”, “front”, “back”, “left”, “right”, “vertical”, “horizontal”. “top”, “bottom”, “inner”, “outer”, “clockwise”, “counterclockwise”, “axial”, “radial”, and “circumferential” are orientation or position relationship shown based on the accompanying drawings, and are merely used for describing this application and simplifying the description, rather than indicating or implying that the mentioned apparatus or element should have a particular orientation or be constructed and operated in a particular orientation, and therefore, should not be construed as a limitation on this application.

In addition, the terms “first” and “second” are used for descriptive purposes only and are not to be construed as indicating or implying relative importance or implicitly indicating the number of technical features indicated. Therefore, features defining “first” and “second” may explicitly or implicitly include at least one of the features. In the description of this application, unless otherwise specified, “multiple” means at least two, for example, two or three.

In this application, unless explicitly specified or limited otherwise, the terms “mounted”, “connected”, “connection”, and “fixed” should be understood in broad sense, for example, the connection may be a fixed connection, a detachable connection, or an integral connection; or the connection may be a mechanical connection or an electrical connection; or the connection may be a direct connection, an indirect connection through an intermediary, or internal communication between two elements or a mutual action relationship between two elements, unless otherwise specified explicitly. A person of ordinary skill in the art can understand specific meanings of the foregoing terms in this application according to a specific situation.

In this application, unless explicitly specified or limited otherwise, a first feature “on” or “under” a second feature may be that the first feature is in direct contact with the second feature, or the first feature is in indirect contact with the second feature through an intermediary. Moreover, the first feature “over”, “above” and “up” the second feature may be that the first feature is directly above or obliquely above the second feature, or simply indicates that a horizontal height of the first feature is higher than that of the second feature. The first feature “under”, “below” and “down” the second feature may be that the first feature is directly below or obliquely below the second feature, or simply indicates that a horizontal height of the first feature is lower than that of the second feature.

It should be noted that, when a component is referred to as “being fixed to” or “being disposed on” another component, the component may be directly on the another component, or an intervening component may also be present. When a component is considered to be “connected to” another component, the component may be directly connected to the another component, or an intervening component may also be present. The terms “vertical”, “horizontal”, “up”, “down”, “left”, “right” and similar expressions used in this specification are only for purposes of illustration but not indicate a unique implementation. In addition, it should be noted that, in the cross-sectional views of the accompanying drawings of this specification, setting of section lines is to more clearly describe a specific structure of the embodiments of this application. In a cross-sectional view, same section lines schematically represent a same component or represent different components using a same material, and a shape of the section line, including an inclination angle and a spacing distance, do not strictly follow section lines settings for different materials in mechanical drawing. For example, in the accompanying drawings of this specification, a section line inclined by 45° does not necessarily represent a metal material, and may also represent another non-metallic material.

In a conventional electronic vaporizer or the related fields thereof, a heating component generally uses a heating wire to directly perform heating and vaporization. The heating component needs to be electrically connected to a main body of the electronic vaporizer through a wire, and installation of the heating component is relatively complex. In addition, to improve the heating efficiency, the heating wire is in direct and close contact with an herbal or paste aerosol-generation substrate, so that the heating wire may be easily polluted. After being polluted, the heating component can be hardly disassembled for separate cleaning,

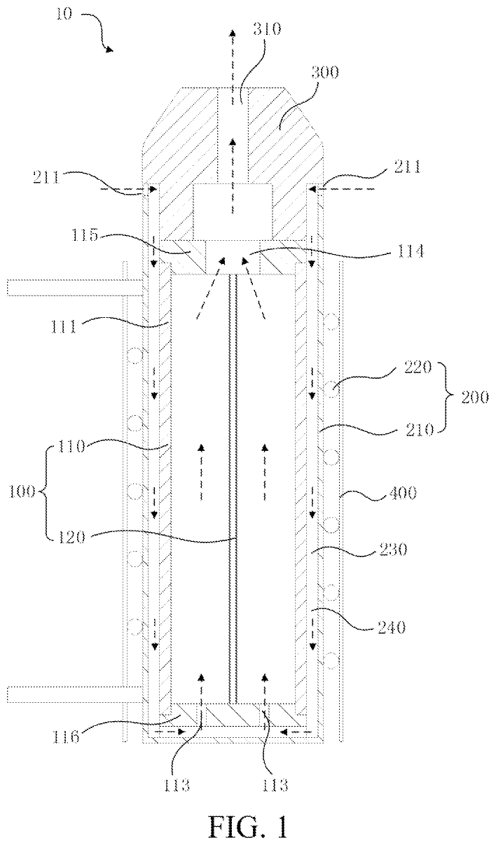

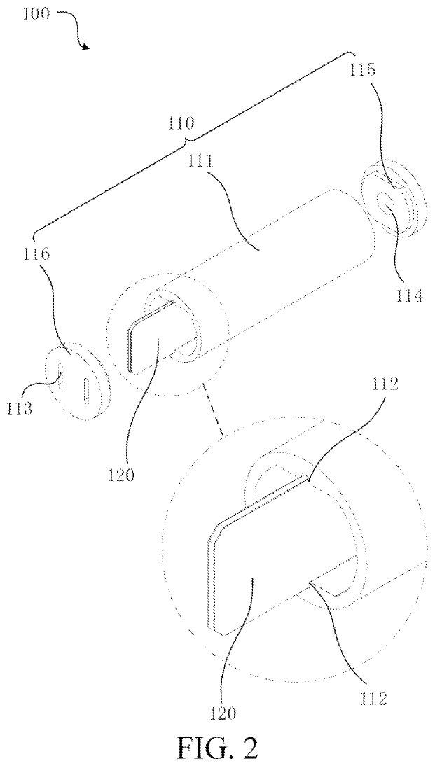

To resolve the foregoing problems, this application provides a heating body and an aerosol-generation device. In an embodiment, as shown in FIG. 1, an aerosol-generation device 10 includes a main body 200, a heating body 100, and a suction nozzle 300. The main body 200 includes a second cylinder body 210 and a magnetic induction coil 220 arranged outside a cylinder wall of the second cylinder body 210, where an accommodating cavity 230 is provided in the second cylinder body 210, and the heating body 100 is detachably arranged in the accommodating cavity 230. The suction nozzle 300 is configured to detachably cover an upper end of the second cylinder body 210, and when the suction nozzle 300 covers the upper end of the second cylinder body 210, the suction nozzle 300 can press and fix the heating body 100 in the accommodating cavity 230. A power supply component (not shown in the figure) is further arranged in the main body 200. The magnetic induction coil 220 is electrically connected to the power supply component, and the magnetic induction coil 220 is configured to form an alternating magnetic field in the accommodating cavity 230. A structure of the heating body 100 is shown in FIG. 1 and FIG. 2. The heating body 100 includes a housing 110 and a heating element 120. The interior of the housing 110 is hollow for accommodating an aerosol-generation substrate, and the heating element 120 is arranged in the housing 110. At least a part of a material of the heating element 120 is a magnetic metal conductor, and the heating element 120 is configured to generate an eddy current in the alternating magnetic field to generate heat, to further heat the aerosol-generation substrate to generate an aerosol.

In addition, as shown in FIG. 1 and HG. 2, the suction nozzle 300 is provided with an airway 310, the housing 110 is provided with an air inlet hole 113 hole and an air outlet hole 114, and both the air inlet hole 113 and the air outlet hole 114 are in communication with the airway 310; one end of the second cylinder body 210 close to the suction nozzle 300 is provided with an air inlet 211, and a gap exists between an outer wall of the heating body 100 and an inner wall of the second cylinder body 210 to serve as an air inlet channel 240. A flow direction of air is shown by arrows in FIG. 1. When a user inhales, the external air enters the housing 110 of the heating element 120 through the air inlet 211, the air inlet channel 240, and the air inlet hole 113 in sequence, and the aerosol in the housing 110 is brought out of the aerosol-generation device 10 through the air outlet hole 114 and the airway 310 in the suction nozzle 300 in sequence for the user to inhale.

In an embodiment, an individual structure of a heating body 100 is shown in FIG. 2, the housing 110 includes a first cylinder body 111, an upper plug 115, and a lower plug 116; the upper plug 115 and the lower plug 116 are respectively arranged at two opposite ends of the first cylinder body 111, the heating element 120 is a sheet heating element 120, an inner wall of the first cylinder body 111 is provided with a first clamping groove 112, and the sheet heating element 120 is clamped in the first clamping groove 112 and then fixed in the housing 110; and the air inlet hole 113 is provided on the lower plug 116, and the air outlet hole 114 is provided on the upper plug 115. In an embodiment, outer surfaces of the upper plug and the lower plug are provided with airflow grooves, and the airflow grooves are configured to guide an airflow and prevent the airflow from being blocked.

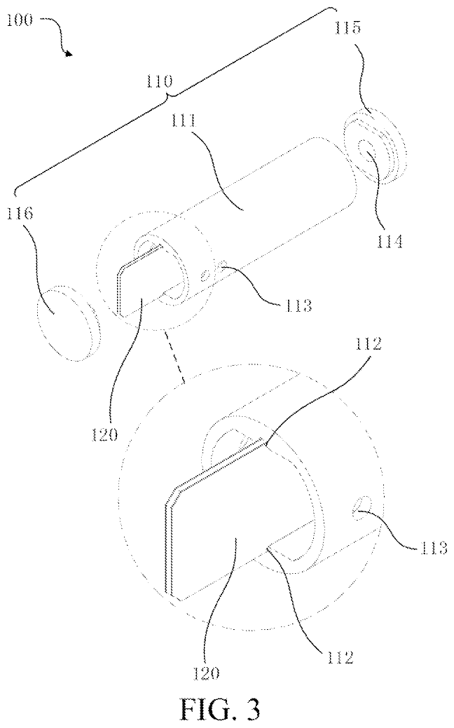

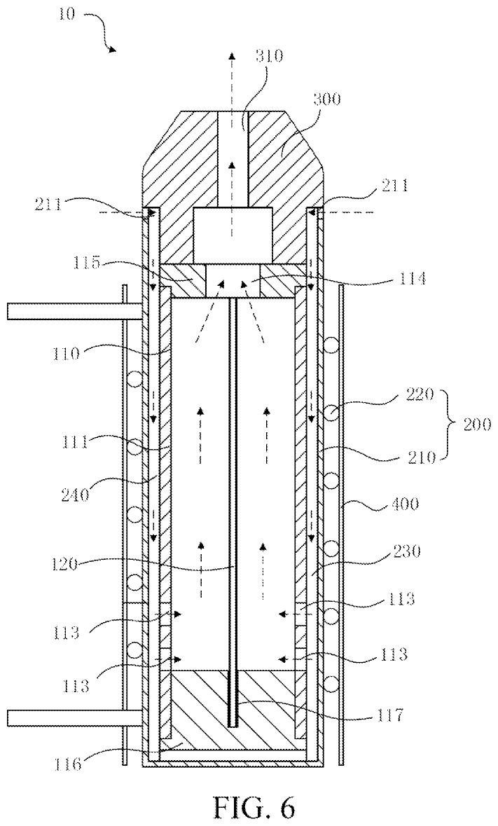

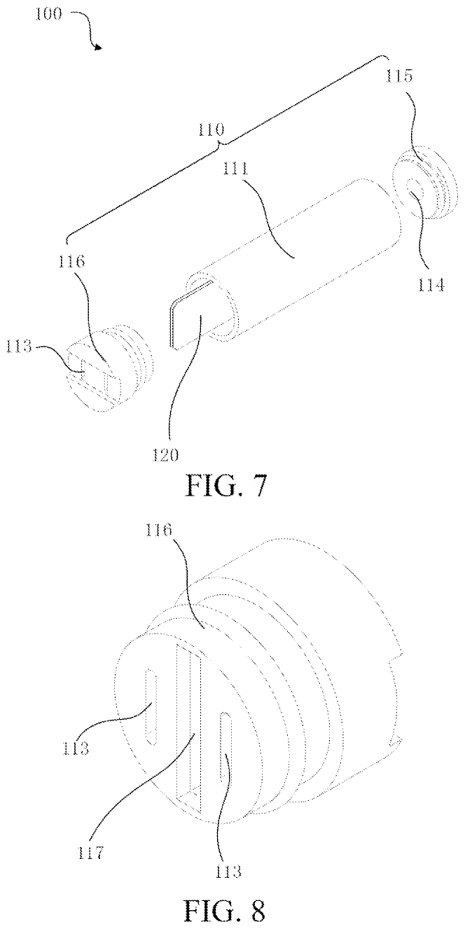

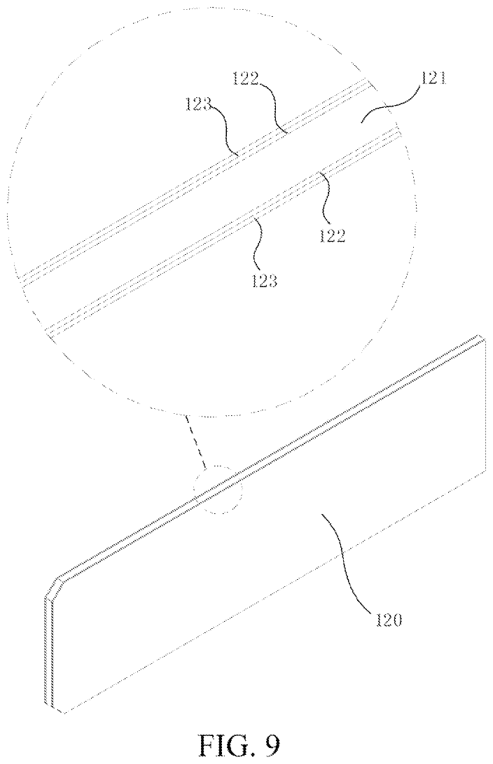

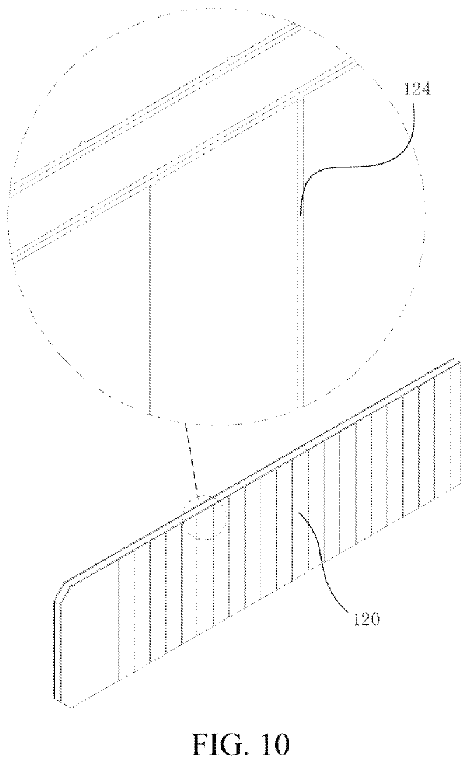

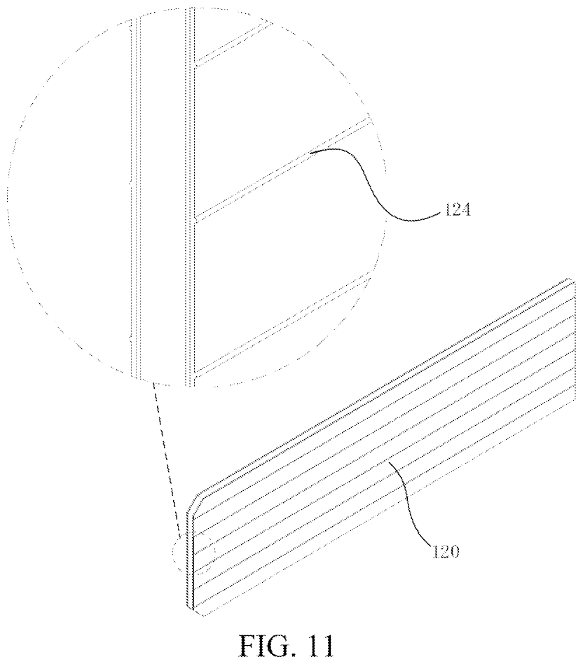

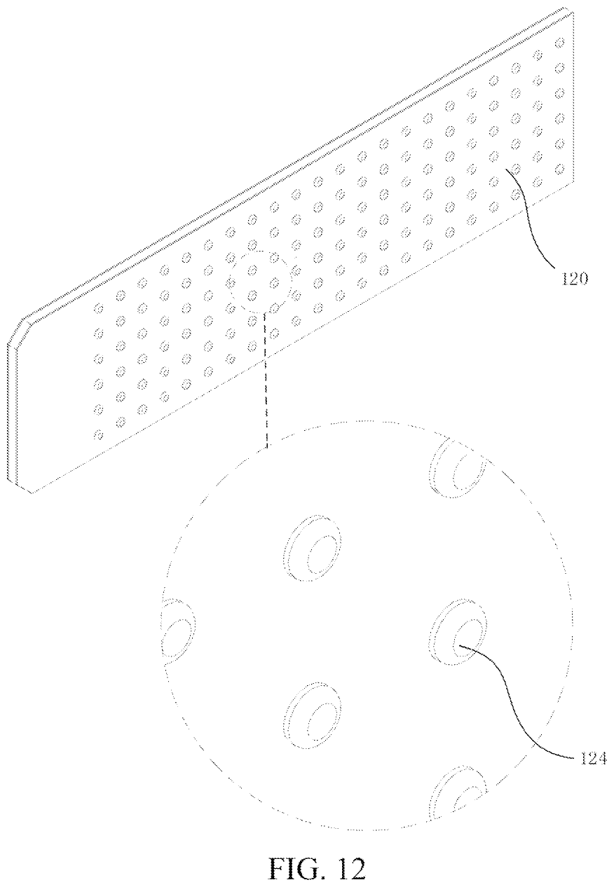

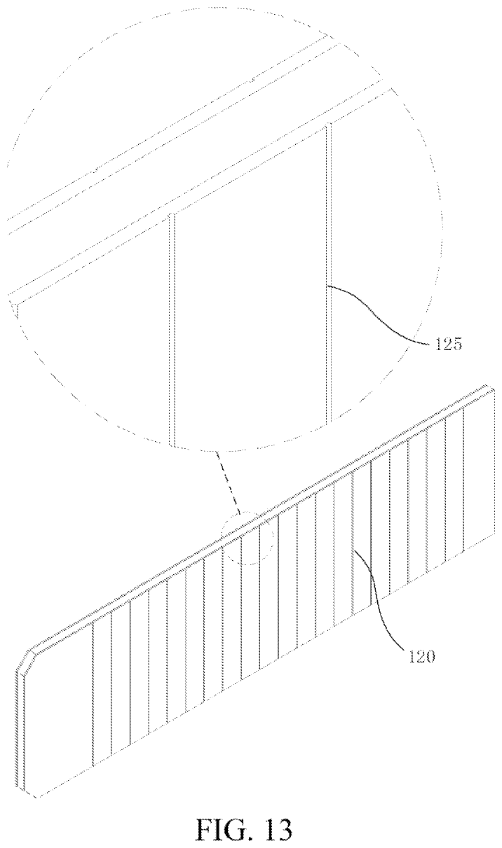

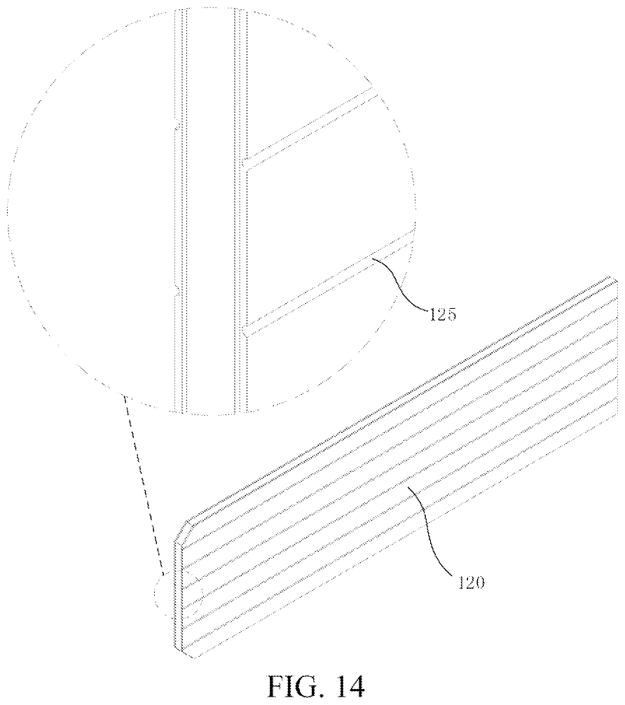

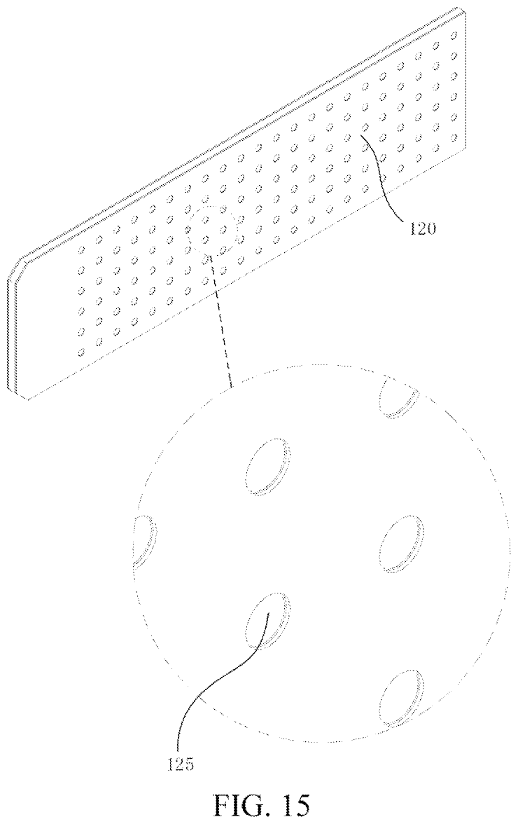

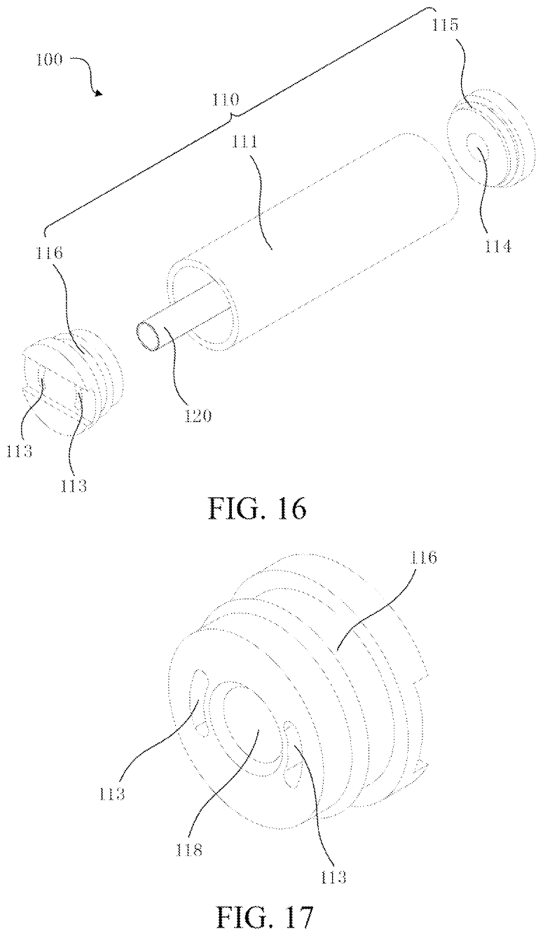

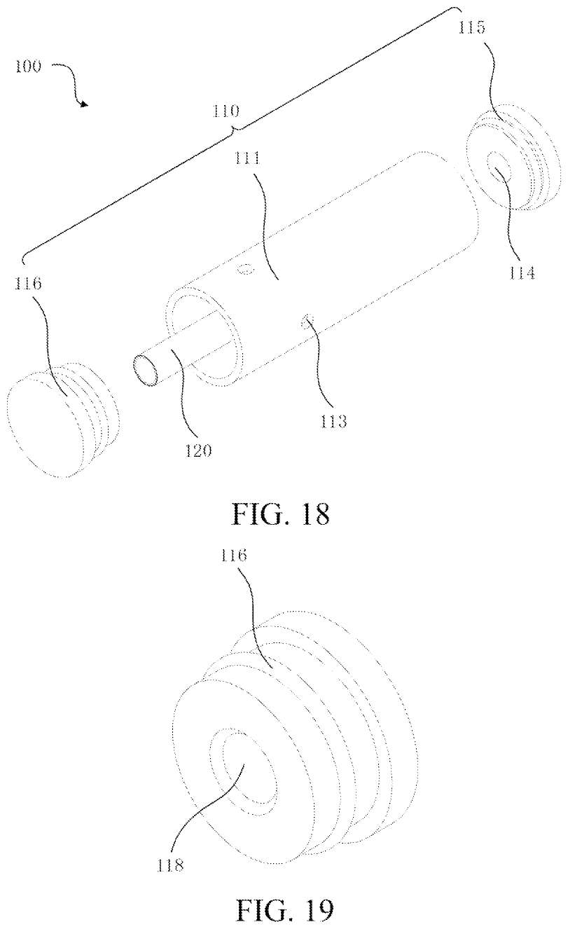

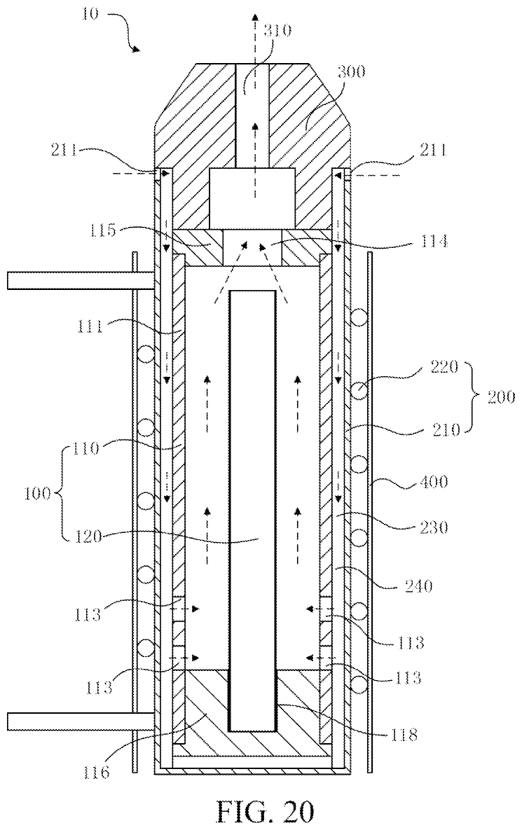

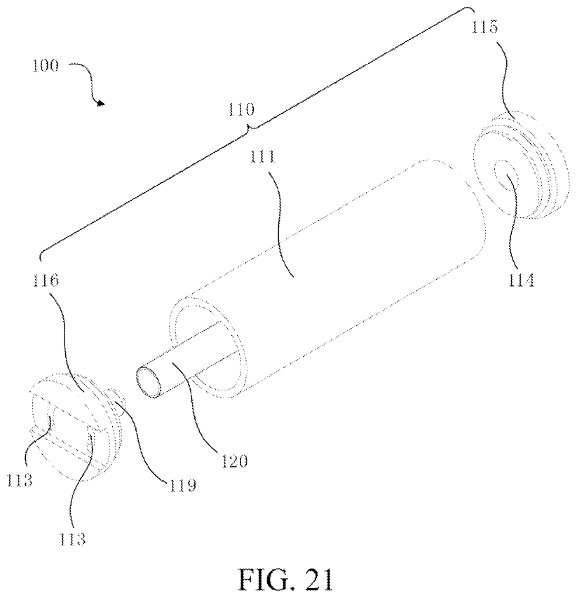

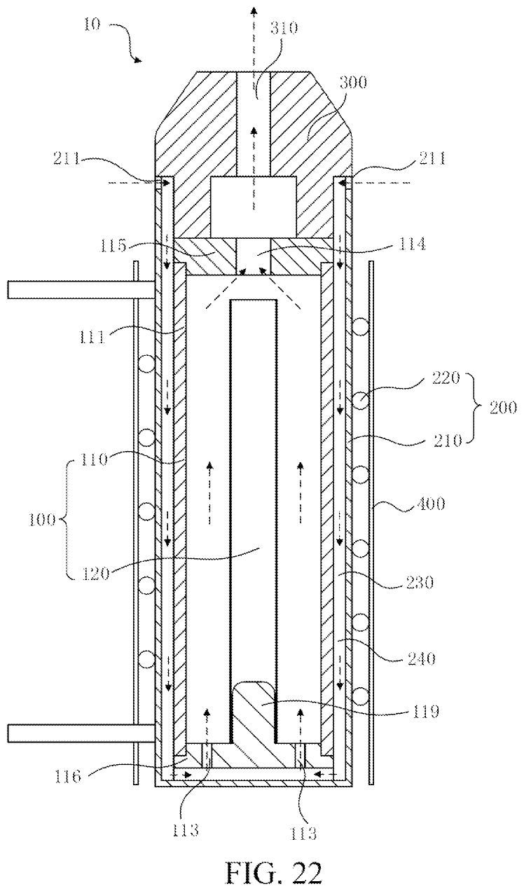

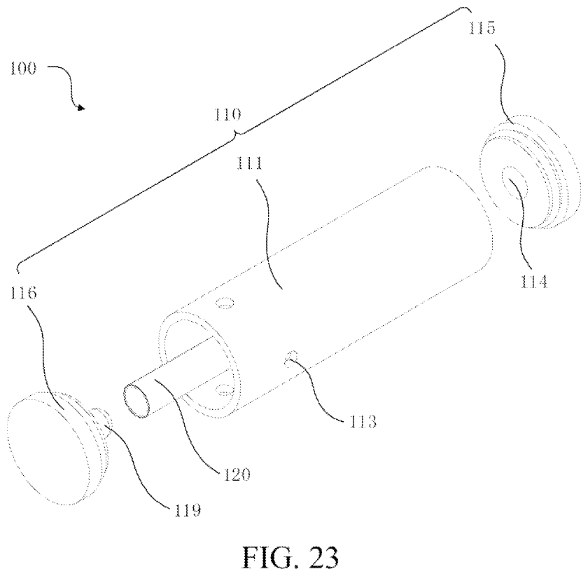

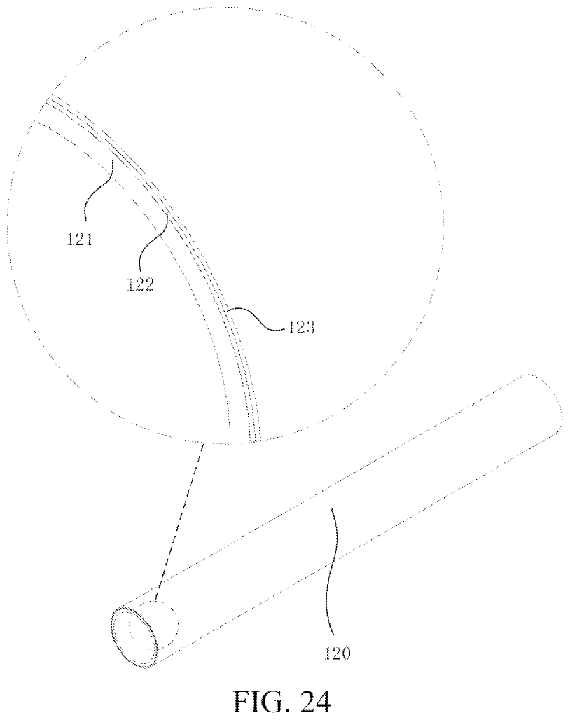

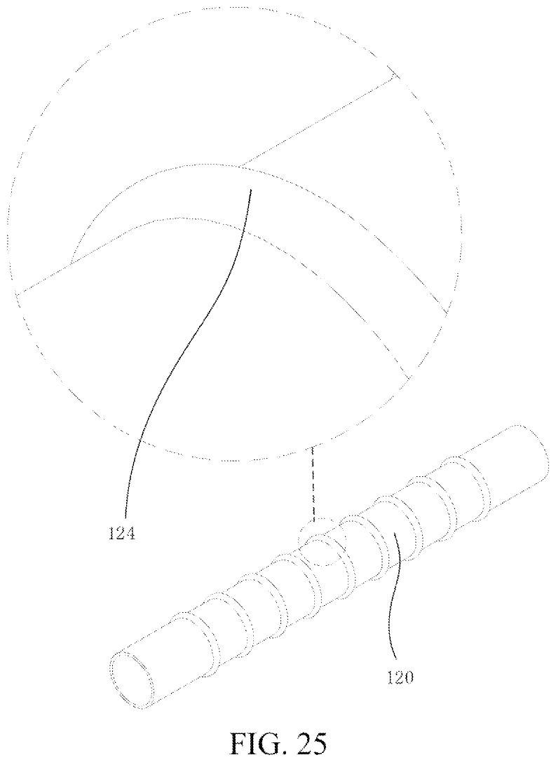

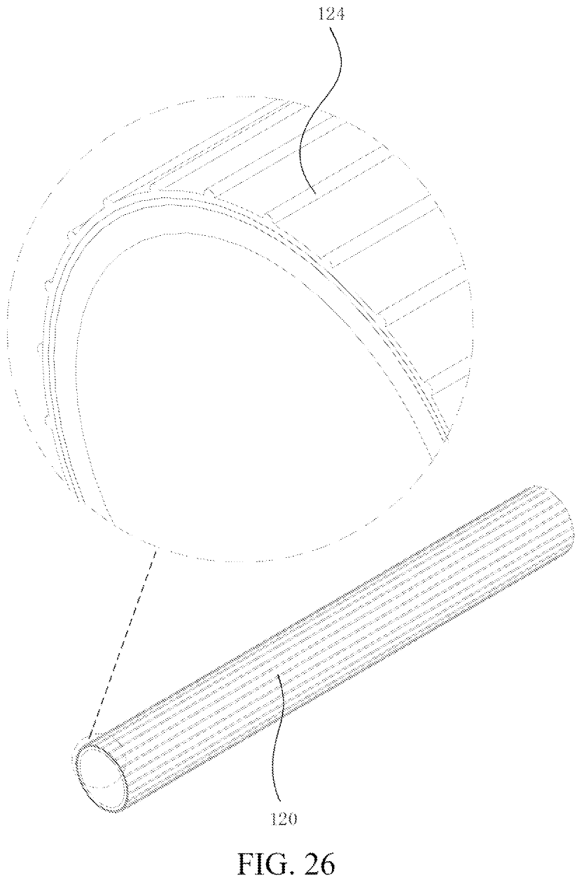

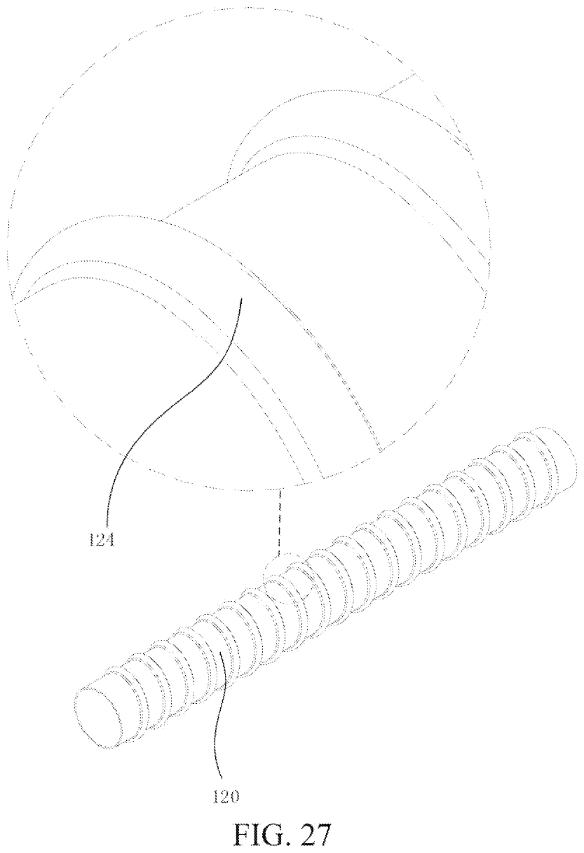

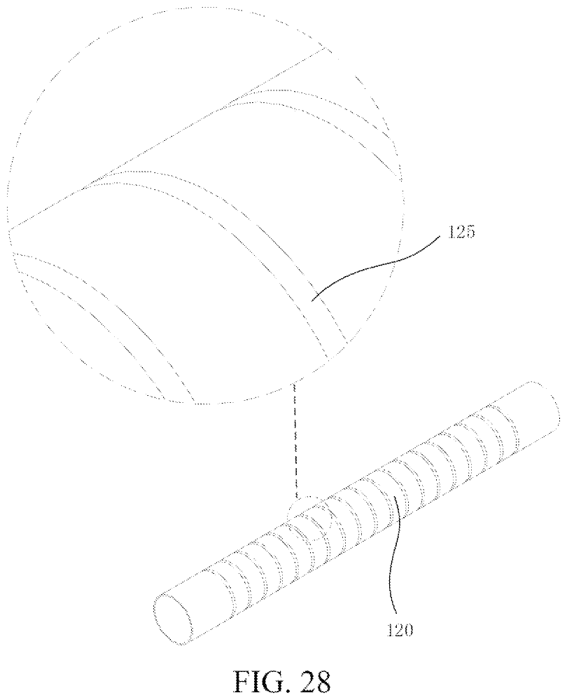

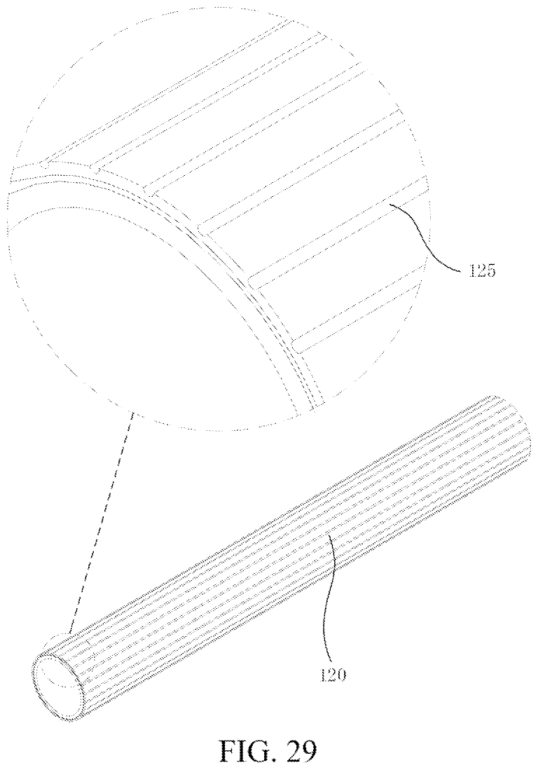

It should be noted that, this application does not limit a fixing manner of the sheet heating element 120 and arrangement positions of the air inlet hole 113 and the air outlet hole 114. In another embodiment, as shown in FIG. 3, an inner wall of the first cylinder body 111 is provided with a first clamping groove 112, and the sheet heating element 120 is clamped in the first clamping groove 112 and then fixed in the housing 110; and the air inlet hole 113 is provided on a cylinder wall of one end of the first cylinder body 111 that is close to the lower plug 116. In another embodiment, as shown in FIG. 4 to FIG. 6, where FIG. 4 is a schematic exploded structural view of a heating element 120, FIG. 5 is a schematic structural diagram of an end of the lower plug 116 that is close to the first cylinder body 111, and FIG. 6 is a schematic longitudinal cross-sectional view of an aerosol-generation device 10 corresponding to FIG. 4 and FIG. 5. As shown in FIG. 4 to FIG. 6, an end surface of the lower plug 116 that is close to the first cylinder body 111 is provided with a second clamping groove 117, and the sheet heating element 120 is clamped in the second clamping groove 117 and is further fixed in the housing 110; and the air inlet hole 113 is provided on a cylinder wall of one end of the first cylinder body 111 that is close to the lower plug 116. In another embodiment, as shown in FIG. 7 and FIG. 8, where FIG. 7 is a schematic exploded structural view of a heating element 120. and. FIG. 8 is a schematic structural diagram of an end of the lower plug 116 that is close to the first cylinder body 111. As shown in FIG. 7 and FIG. 8, the air inlet hole 113 is provided on the lower plug 116, an end surface of the lower plug 116 that is close to the first cylinder body 111 is provided with a second clamping groove 117, and the sheet heating element 120 is clamped in the second clamping groove 117 and is further fixed in the housing 110.

In an embodiment, a structure of the sheet heating element 120 is shown in FIG. 9, the sheet heating element 120 includes a magnetic metal conductor 121, a first thermal conductive layer 122, and a second thermal conductive layer 123 in sequence in a thickness direction from the center to the outside. The first thermal conductive layer 122 covers the outside of the magnetic metal conductor 121, the second thermal conductive layer 123 covers the outside of the first thermal conductive layer 122, a thermal conductivity of the first thermal conductive layer 122 is higher than that of the second thermal conductive layer 123, and the second thermal conductive layer 123 is in direct contact with the aerosol-generation substrate. In a specific embodiment, the magnetic metal conductor 121 is made of ferrite stainless steel, nickel, nickel alloy, iron-based alloy, or cobalt-based alloy, and a thickness thereof ranges from 0.1 mm to 0.6 mm, and preferably, ranges from 0.1 mm to 0.3 mm. The first thermal conductive layer 122 is a high thermal conductive ceramic, and the thermal conductivity thereof ranges from 15 W/(m·k) to 26 W/(m·k), and a thickness thereof ranges from 0.02 mm to 0.5 mm. A material of the second thermal conductive layer 123 is low thermal conductive glass, the thermal conductivity is similar to that of the baked aerosol-generation substrate, the thermal conductivity thereof ranges from 0.04 W/(m·K) to 0.08 W/(m·k), and a thickness thereof ranges from 0.02 mm to 0.05 mm. The magnetic metal conductor 121 generates an eddy current in the alternating magnetic field to generate heat, and the eddy current may diffuse outward through the first thermal conductive layer 122 and the second thermal conductive layer 123 sequentially. The high thermal conductivity of the first thermal conductive layer 122 cause an uneven temperature field of the magnetic metal conductor 121 to be uniform after heat is transferred to the first thermal conductive layer 122, and the low thermal conductivity of the second thermal conductive layer 123 may prevent the heat of the first thermal conductive layer 122 from being quickly transferred to the baked herbal or paste aerosol-generation substrate, thereby avoiding excessive carbonization surrounding the sheet heating element 120 and occurrence of a burnt flavor and/or toxic chemical substances.

In a specific embodiment, an outer surface of the sheet heating element 120 may be a smooth surface or a frosted surface, or an outer surface of the sheet heating element 120 may be provided with a protruding structure 124 or a groove structure 125. In a specific embodiment, the roughness Ra of the smooth surface is less than or equal to 6.3 μm; the roughness Ra of the frosted surface is greater than or equal to 50 μm; and a height of the protruding structure 124 or a depth of the groove structure 125 ranges from 0.1 mm to 0.3 mm. The sheet heating element 120 with a smooth or frosted surface is mainly configured to bake an herbal aerosol-generation substrate; and the heating element 120 provided with a protruding structure 124 or a groove structure 125 on the outer surface is mainly configured to bake a paste aerosol-generation substrate, which can prevent the paste aerosol-generation substrate from sliding down. A gap between the texture of the protruding structure 124 or the groove structure 125 may store the paste aerosol-generation substrate and effectively increase a contact area. In addition, because the second thermal conductive layer 123 of the sheet heating element 120 that is in direct contact with the aerosol-generation substrate is made of a low thermal conductivity glass material, the paste aerosol-generation substrate may be heated evenly without spattering caused by a large temperature difference.

In a specific embodiment, the protruding structure 124 on the outer surface of the sheet heating element 120 may be a horizontal strip-shaped protrusion 119. As shown in FIG. 10, the horizontal strip-shaped protrusion 119 extends in a width direction of the sheet heating element 120. In another specific embodiment, the protruding structure 124 on the outer surface of the sheet heating element 120 may be a vertical strip-shaped protrusion 119. As shown in FIG. 11, the vertical strip-shaped protrusion 119 extends in a length direction of the sheet heating element 120.

In still another specific embodiment, the protruding structure 124 on the outer surface of the sheet heating element 120 may be a dot-shaped protrusion. As shown in FIG. 11, the dot-shaped protrusion is distributed on the outer surface of the sheet heating element 120 in an array.

In a specific embodiment, the groove structure 125 on the outer surface of the sheet heating element 120 may be a horizontal strip-shaped groove. As shown in FIG. 13, the horizontal strip-shaped groove extends in a width direction of the sheet heating element 120. In another specific embodiment, the groove structure 125 on the outer surface of the sheet heating element 120 may be a vertical strip-shaped groove. As shown in FIG. 14, the vertical strip-shaped groove extends in a length direction of the sheet heating element 120. In still another specific embodiment, the groove structure 125 on the outer surface of the sheet heating element 120 mayo be a dot-shaped groove. As shown in FIG. 15, the dot-shaped groove is distributed on the outer surface of the sheet heating element 120 in an array.

It should be noted that, this application does not limit a specific shape of the heating element 120 in the heating body 100. In the embodiments shown in FIG. 1 to FIG. 15, the heating elements 120 of the heating body 100 are all sheet heating elements 120. It may be understood that in other embodiments, the heating element 120 in the heating body 100 may also be in another shape. For example, in another embodiment, as shown in FIG. 16 and FIG. 17, the heating element 120 is a tubular heating element 120, where the tubular heating element 120 is fastened to the end of the lower plug 116 that is close to the second cylinder body 210 and then fixed in the housing 110. Specifically, as shown in FIG. 16 and FIG. 17, an end surface of the lower plug 116 that is close to the first cylinder body 111 is provided with a third clamping groove 118, and the sheet heating element 120 can be clamped in the third clamping groove 118 and then fixed in the housing 110. In addition, it should be noted that, similar to the embodiments of the sheet heating element 120, when the heating element 120 is a tubular heating element 120, the air inlet hole 113 may be provided on the lower plug 116, as shown in FIG. 16 and FIG. 17; and the air inlet hole 113 may be arranged on the cylinder wall of the end of the first cylinder body 111 that is close to the lower plug 116, as shown in FIG. 18 and FIG. 19. A longitudinal cross-sectional view of the aerosol-generation device 10 corresponding to FIG. 18 and FIG. 19 is shown in FIG. 20. The end surface of the lower plug 116 that is close to the first cylinder body 111 is provided with a third clamping groove 118, the tubular heating element 120 can be clamped in the third clamping groove 118 and then fixed in the housing 110, and the air inlet hole 113 is provided on the cylinder wall of the end of the first cylinder body 111 that is close to the lower plug 116.

In another embodiment, as shown in FIG. 21 and FIG. 22, where FIG. 21 is a schematic exploded structural view of a heating element 120, and FIG. 22 is a schematic longitudinal cross-sectional view of an aerosol-generation device 10 corresponding to FIG. 21. As shown in FIG. 21 and. FIG. 22, the air inlet hole 113 is provided on the lower plug 116, the end surface of the lower plug 116 that is close to the first cylinder body 111 is provided with a protrusion 119, and the tubular heating element 120 is sleeved on and fixed outside of the protrusion 119 and is further fixed in the housing 110. In another embodiment, as shown in FIG. 23, the air inlet hole 113 is provided on the cylinder wall of the end of the first cylinder body 111 that is close to the lower plug 116, the end surface of the lower plug 116 that is close to the first cylinder body 111 is provided with a protrusion 119, and the tubular heating element 120 is sleeved on and fixed outside of the protrusion 119 and is further fixed in the housing 110.

That is, regardless of whether the heating element 120 is a sheet heating element 120 or a tubular heating element 120, the air inlet hole 113 may be provided on the lower plug 116 or on the cylinder wall of the end of the first cylinder body 111 that is close to the lower plug 116. In a specific embodiment, a specific position of the air inlet hole 113 may be set according to a specific use of the heating element 120, For example, when the heating element 120 is mainly configured to bake an herbal solid aerosol-generation substrate, the air inlet hole 113 is preferentially provided on the lower plug 116, as shown in FIG. 1 and FIG. 22, and the airflow flows axially, so that the user inhales smoothly, and the aerosol can be brought out at the first time. In addition, when the air inlet hole 113 is provided on the lower plug 116, the air inlet hole 113 is symmetrically distributed on two opposite sides of the lower plug 116, as shown in FIG. 1 and FIG. 22, so that the airflow can more fully circulate in the gap, thereby bringing out the aerosol component. When the heating element 120 is mainly configured to bake a paste aerosol-generation substrate, the air inlet hole 113 is preferentially provided on the cylinder wall of the end of the first cylinder body 111 that is close to the lower plug 116, as shown in FIG. 6 and HG 20, so that liquid can be prevented from leaking out of the heating body 100, resulting in a low utilization rate or pollution on the second cylinder body 210 of the main body 200.

In addition, regardless of whether the heating element 120 is a sheet heating element 120 or a tubular heating element 120, the heating element 120 may be detachably arranged in the heating body 100, and the heating body 100 may also be detachably arranged in the accommodating cavity 230 of the second cylinder body 210. Therefore, the heating body 100 may be taken out from the aerosol-generation device 10 independently, and the heating element 120 may be taken out from the heating body 100 independently. When the aerosol-generation substrate is an herbal solid aerosol-generation substrate, the solid aerosol-generation substrate may be filled into a cavity between the first cylinder body 111 and the sheet heating element 120 or the tubular heating element 120 by removing the upper plug 115. When the aerosol-generation substrate is a paste aerosol-generation substrate, the paste aerosol-generation substrate may be coated on the outer surface of the heating element 120 by taking out the heating element 120. In addition, after the upper plug 115, the lower plug 116, and the heating element 120 are removed, the first cylinder body 111 of the heating body 100 is a straight cylinder body, which is convenient for cleaning. In addition, it should be noted that, this application does not limit a cross-sectional shape of the first cylinder body 111, and in a specific embodiment, the cross-sectional shape of the first cylinder body 111 may be in a shape of a circle, an ellipse, a square, or another shape. In addition, in a specific embodiment, the material of the first cylinder body 111 may be high temperature resistant glass or polycarbonate, and the material of the upper plug 115 and/or the lower plug 116 may be high temperature resistant silica gel, or, the upper plug 115 and/or the lower plug 116 include a plug pillar and an O-shaped sealing ring arranged outside the plug pillar.

In addition, similar to the embodiment shown in FIG. 9, when the heating element 120 is a tubular heating element 120, the tubular heating element 120 also includes a three-layer structure, as shown in FIG. 24, from an inner wall to an outer wall, includes a magnetic metal conductor 121, a first thermal conductive layer 122, and a second thermal conductive layer 123 sequentially. The first thermal conductive layer 122 covers the outside of the first thermal conductive layer 122, the second thermal conductive layer 123 covers the outside of the first thermal conductive layer 122, a thermal conductivity of the first thermal conductive layer 122 is higher than that of the second thermal conductive layer 123, and the second thermal conductive layer 123 is in direct contact with the aerosol-generation substrate. In addition, when the heating element 120 is a tubular heating element 120, for materials and thicknesses of the magnetic metal conductor 121, the first thermal conductive layer 122, and the second thermal conductive layer 123, reference may be made to the related descriptions in the embodiment shown in FIG. 9, which are not be described herein again.

In addition, similar to the embodiments shown in FIG. 9, FIG. 10, FIG. 11, FIG. 13, and FIG. 14, when the heating element 120 is a tubular heating element 120, the outer surface of the tubular heating element 120 may also be a smooth surface or a frosted surface, or the outer surface of the tubular heating element 120 may be provided with a protruding structure 124 or a groove structure 125. For the roughness of the smooth surface, the roughness of the frosted surface, a height of the protruding structure 124, and a depth of the groove structure 125, reference may be made to the related descriptions in the sheet heating element 120, which are not described herein again.

In a specific embodiment, the tubular heating element 120 is a circular tube, and the protruding structure 124 on the outer surface of the tubular heating element 120 may be a radial annular protrusion, as shown in FIG. 25, where the radial direction is a radial direction of the tubular heating element 120. In another specific embodiment, the protruding structure 124 on the outer surface of the tubular heating element 120 may be an axial strip-shaped protrusion, as shown in FIG. 26, where the axial direction is an axial direction of the tubular heating element 120. In still another specific embodiment, the protruding structure 124 on the outer surface of the tubular heating element 120 may be a spiral protrusion, as shown in FIG. 27.

In a specific embodiment, the groove structure 125 on the outer surface of the tubular heating element 120 may be a radial annular groove, as shown in FIG. 28, where the radial direction is a radial direction of the tubular heating element 120. In another specific embodiment, the groove structure 125 on the outer surface of the tubular heating element 120 may be an axial strip-shaped groove, as shown in FIG. 29, where the axial direction is an axial direction of the tubular heating element 120. In still another specific embodiment, the groove structure 125 on the outer surface of the tubular heating element 120 may be a spiral groove (not shown in the figure).

In addition, in a specific embodiment, as shown in FIG. 1, there is a magnetic attraction force between the suction nozzle 300 and the second cylinder body 210, and the suction nozzle 300 is connected with the second cylinder body 210 through the magnetic attraction force and presses and fixes the heating body 100 in the accommodating cavity 230 of the second cylinder body 210. In addition, in an embodiment, as shown in FIG. 1, the aerosol-generation device 10 further includes a ferrite film 400, where the ferrite film 400 is sleeved on the outside of the magnetic induction coil 220 to shield the magnetic field generated by the magnetic induction coil 220 and prevent leakage of the magnetic field.

According to the heating body 100 and the aerosol-generation device 10 provided in this application, by adopting a magnetic induction heating manner, arrangement of a conductive circuit structure between the heating body 100 and the main body 200 is avoided, and the heating body 100 is detachably arranged in the aerosol-generation device 10, so that the heating body 100 can be taken out independently. Therefore, it is convenient to place an aerosol-generation substrate in the heating body 100, and it is convenient to replace and clean the heating body 100, so that the heating body 100 may be manufactured into disposable consumables and may also be reused.

The technical features in the foregoing embodiments may be randomly combined. For concise description, not all possible combinations of the technical features in the embodiments are described. However, provided that combinations of the technical features do not conflict with each other, the combinations of the technical features are considered as falling within the scope described in this specification.

The foregoing embodiments merely express several implementations of this application. The descriptions thereof are relatively specific and detailed, but should not be construed as a limitation to the patent scope of this application. It should be noted that, a person of ordinary skill in the art may still make various changes and improvements without departing from the idea of this application, and the changes and improvements shall all fall within the protection scope of this application. Therefore, the protection scope of this application shall be subject to the appended claims.

What is claimed is:

1. A heating body, detachably arranged in an aerosol-generation device, comprising:
a housing for accommodating an aerosol-generation substrate, the housing having an air inlet hole and an air outlet hole; and
a heating element arranged in the housing and configured to generate heat through an eddy current in an alternating magnetic field, the aerosol-generation substrate generating an aerosol in response to the heat from the heating element.

2. The heating body according to claim 1, wherein the housing comprises:
a first cylinder body;
an upper plug; and
a lower plug,
wherein the upper plug and the lower plug are respectively arranged at two opposite ends of the first cylinder body, the heating element is detachably arranged in the first cylinder body, the air inlet hole is provided on the lower plug or on a cylinder wall of one end of the first cylinder body that is close to the lower plug, and the air outlet hole is provided on the upper plug.

3. The heating body according to claim 2, wherein outer surfaces of the upper plug and the lower plug are provided with airflow grooves, and the airflow grooves are configured to guide an airflow and prevent the airflow from being blocked.

4. The heating body according to claim 2, wherein the heating element is a sheet heating element, an inner wall of the first cylinder body is provided with a first clamping groove, and the sheet heating element is clamped in the first clamping groove.

5. The heating body according to claim 2, wherein the heating element is a sheet heating element, an end surface of the lower plug that is close to the first cylinder body is provided with a second clamping groove, and the sheet heating element is clamped in the second clamping groove.

6. The heating body according to claim 4, wherein the sheet heating element comprises a magnetic metal conductor, a first thermal conductive layer, and a second thermal conductive layer in sequence from the center to the outside, a thermal conductivity of the first thermal conductive layer is higher than that of the second thermal conductive layer, and the second thermal conductive layer is in direct contact with the aerosol-generation substrate.

7. The heating body according to claim 2, wherein the heating element is a tubular heating element, an end surface of the lower plug that is close to the first cylinder body is provided with a third clamping groove, and the tubular heating element is clamped in the third clamping groove.

8. The heating body according to claim 2, wherein the heating element is a tubular heating element, an end surface of the lower plug that is close to the first cylinder body is provided with a protrusion, and the tubular heating element is sleeved on and fixed outside the protrusion.

9. The heating body according to claim 7, wherein the tubular heating element comprises a magnetic metal conductor, a first thermal conductive layer, and a second thermal conductive layer in sequence from an inner wall to an outer wall, a thermal conductivity of the first thermal conductive layer is higher than that of the second thermal conductive layer, and the second thermal conductive layer is in direct contact with the aerosol-generation substrate.

10. The heating body according to claim 6, wherein a thickness of the magnetic metal conductor ranges from 0.1 mm to 0.6 mm, the thermal conductivity of the first thermal conductive layer ranges from 15 W/(m·k) to 26 W/(m·k), a thickness of the first thermal conductive layer ranges from 0.02 mm to 0.5 mm, and the thermal conductivity of the second thermal conductive layer ranges from 0.04 W/(m·k) to 0.08 W/(m·k), and a thickness of the second thermal conductive layer ranges from 0.02 mm to 0.05 mm.

11. The heating body according to claim 2, wherein an outer surface of the heating element includes at least one of a smooth surface, a frosted surface, a protruding structure, or a groove structure.

12. The heating body according to claim 11, wherein the roughness Ra of the smooth surface is less than or equal to 6.3 μm, the roughness Ra of the frosted surface is greater than or equal to 50 μm, and a height of the protruding structure or a depth of the groove structure ranges from 0.1 mm to 0.3 mm.

13. The heating body according to claim 11, wherein the heating element is a sheet heating element, the protruding structure includes one of a horizontal strip-shaped protrusion, a vertical strip-shaped protrusion, or a dot-shaped protrusion, and the groove structure includes one of a horizontal strip-shaped groove, a vertical strip-shaped groove, or a dot-shaped groove.

14. The heating body according to claim 11, wherein the heating element is a tubular heating element, the protruding structure includes one of a radial annular protrusion, an axial strip-shaped protrusion, or a spiral protrusion, and the groove structure includes one of a radial annular groove, an axial strip-shaped groove, or a spiral groove.

15. The heating body according to claim 2, wherein at least one of the upper plug or the lower plug is made of a silica gel material.

16. The heating body according to claim 2 wherein at least one of the upper plug or the lower plug comprises a plug pillar and a sealing ring arranged outside the plug pillar.

17. An aerosol-generation device, comprising:
a main body having a cavity;
a power supply component disposed in the main body;
a magnetic induction coil disposed outside a cavity wall of the cavity and electrically coupled to the power supply component, the magnetic induction coil being configured to form an alternating magnetic field in the cavity; and
a heating body detachably disposed in the main body, comprising:
a housing for accommodating an aerosol-generation substrate, the housing having an air inlet hole and an air outlet hole; and
a heating element arranged in the housing and configured to generate heat through an eddy current in the alternating magnetic field, the aerosol-generation substrate generating an aerosol in response to the heat from the heating element.

18. The aerosol-generation device according to claim 17, further comprising a suction nozzle, wherein the suction nozzle is in communication with the air inlet hole and the air outlet hole, the suction nozzle is configured to detachably cover an upper end of the main body, and the suction nozzle is further configured to press and fix the heating body in the cavity.

19. The aerosol-generation device according to claim 18, wherein the suction nozzle and the main body are coupled through a magnetic force.

20. The aerosol-generation device according to claim 17, further comprising a ferrite fila sleeved on the outside of the magnetic induction coil.
